(19) United States
(12) Patent Application Publication
(10) Pub. No.: US 2003/0051380 A1
(43) Pub. Date: Mar. 20, 2003

(54) Apparatus and method for forming a backlit visual display

(76) Inventors: Emmer T. Butler, Parker, CO (US); Cynthia A. Craft, Lakewood, CO (US); Neil A. Daley, Arvada, CO (US)

Correspondence Address: Bruce A. Kugler, Esq., SHERIDAN ROSS P.C., 1560 Broadway, Suite 1200, Denver, CO, 80202-5141, US

(21) Appl. No.: 10/241,501

(22) Filed: Sep. 10, 2002

Related U.S. Application Data
(60) Provisional application No. 60/318,588, filed on Sep. 10, 2001.

(51) Int. Cl. G09F 13/04; G09F 19/00

(52) U.S. Cl. 40/564; 40/615

(57) ABSTRACT

A backlit sign is provided which utilizes a diffuser layer of numerous inks in a composition which allows the transmission of an illuminating source of light, but which substantially prevents the viewing of the source of light

This application claims priority of U.S. provisional patent application Serial No. 60/318,588 having a filing date of Sep. 10, 2001 and is incorporated herein in its entirety by reference.

### FIELD OF THE INVENTION

The present invention relates to sign technology, and more specifically backlit visual displays which utilize unique compositions of inks and diffuser materials to distort the light source while providing sufficient illumination to display a sign or image.

### BACKGROUND OF THE INVENTION

The use of signs to display information, instructions, and advertisements are well known and are typically constructed by applying some form of ink, paint, or other material to a substrate backing material to identify lettering, graphics, directions, or other useful information. For nighttime applications, backlit signs have been provided which utilize a light source to illuminate a message or information to enhance the messages and desired sign information. These backlit signs are especially useful during low light conditions, although they are also used during daylight hours to enhance the sign image. One type of backlit sign commonly utilizes a light emitting diode (LED) source which provides light through one of a series of substrates or ink materials to illuminate an image or a message. One significant problem, however has been the inability of manufacturers and sign makers to create a sign which illuminates a message or other information, but which does not allow the light source to be seen by a viewer. Thus, often a “hot spot” of light can be seen which identifies the individual LEDs or other illuminating source, and which significantly distorts the image which is meant to be conveyed by the sign maker. Thus, there is a significant need in the art to provide a novel backlit sign which is capable of illuminating an image or message, but which obscures the light source which is positioned behind the sign or image. It is thus one aspect of the present invention to address this problem and to provide a method and apparatus which provides an improved backlit sign as set forth hereinbelow.

### SUMMARY OF THE INVENTION

It is thus one aspect of the present invention to provide a backlit sign manufacturing process and apparatus which prominently displays an image or information in an illuminated state, while not identifying the source of light which is projecting from a rearward portion of the sign. In one embodiment of the present invention, a process and composition is provided which includes utilizing a plurality of different inks and films applied to a substrate and which further includes a novel diffuser incorporating numerous types of inks which allow an image to be illuminated without identifying the light source. Thus, the present invention maybe utilized for any printed image applied on clear or translucent materials such as polycarbonates which are backlit by a light source and that offer some diffusion or moderation of light.

It is another aspect of the present invention to utilize the diffusion inks and compositions in non-signage applications, such as overhead light sources, traffic lights, or on/off indicator lights which do not have any specific lettering or graphics displayed. Thus, the present invention could be used to obscure the bulbs in overhead flourescent light applications (or other light sources) or may be used in applications where no specific graphics are illuminated, i.e., such as an on/off indicator for a gasoline pump.

It is yet another aspect of the present invention to provide a cost effective method for manufacturing a backlit light source which utilizes conventional materials and inks which are applied on one or more substrates, and which allow for the illumination of signs even in daylight conditions to indicate an “on/off” source for users, such as signs used at gasoline stations and fast food drive through restaurants. As discussed hereinbelow, this result is obtained by utilizing a novel ink diffusion formulation which is applied with consideration of the thickness of materials, the color and image being backlit, the distance between the LEDs and the graphic panel, the color and strength of LEDs associated with the backlit sign, and other factors related thereto. Thus, for different applications and types of backlit signs, the type of diffuser material, LEDs, and other materials may vary as appreciated by one skilled in the art.

Thus, in one aspect of the present invention a backlit sign is provided for illuminating an image, and comprises:

a substrate layer having a front side and a backside;

a background ink layer applied to said backside of said substrate having at least one distinct color;

at least one additional ink layer applied to said background ink to create an image;

a diffuser layer applied to said at least one additional ink and comprising:

a) an opaque white gloss vinyl ink having a percentage by weight of between about 20%-30%;

b) a clear mixing gloss vinyl ink having a percentage by weight of between 50%-60%;

c) a matte additive ink in a percentage by weight of between about 15%-20%; and

a light source provided behind said diffuser layer.

In an alternative embodiment of the present invention, the diffuser may be formulated without utilizing the matte additive inks.

### BRIEF DESCRIPTION OF THE DRAWINGS

FIG. 1 is a front elevation view of an embodiment of the present invention showing a backlit sign;

FIG. 2 is a front elevation view of a portion of the embodiment shown in FIG. 1;

FIG. 3 is a rear elevation view of a portion of the embodiment shown in FIG. 1;

FIG. 4 is a exploded perspective view of a portion of the embodiment shown in FIG. 1; and

FIG. 5 is a cross sectioned bottom plan view of the embodiment shown in FIG. 4.

### DETAILED DESCRIPTION

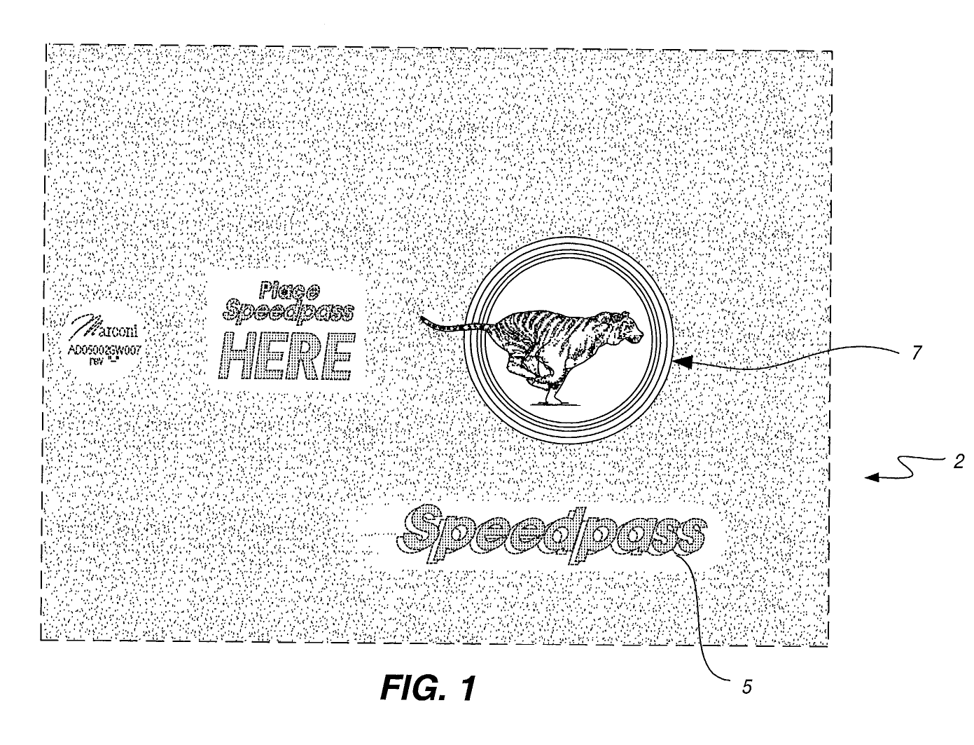

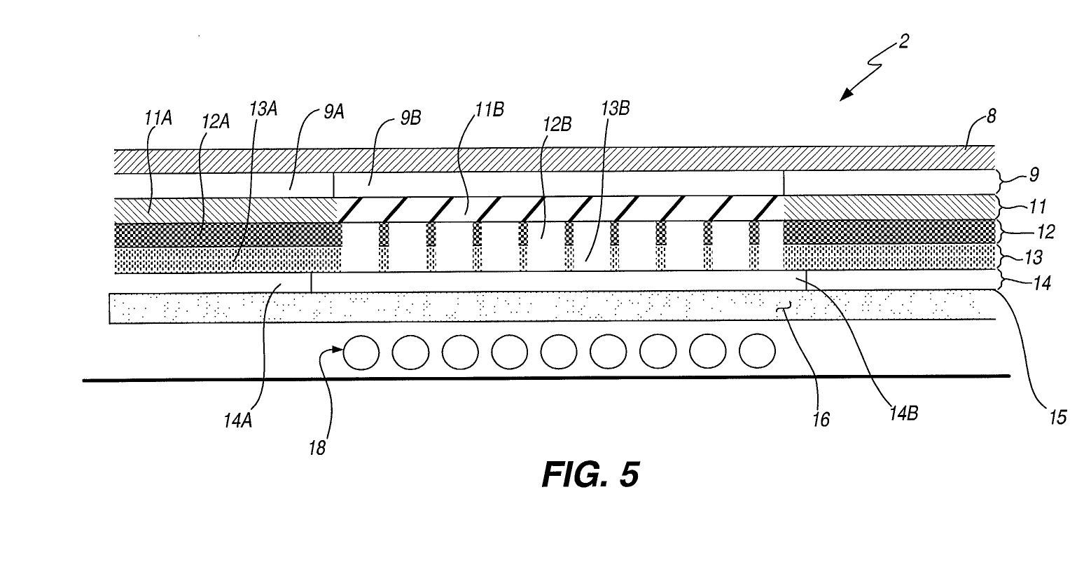

Referring now to the drawings, FIGS. 1-5 show one embodiment of the present invention. More specifically, these figures depict the backlit portion of a sign and the preferred layers of substrates and inks required to achieve the light distorting effect.

Referring now to FIG. 1, one embodiment of the present invention is shown herein. The embodiment illustrated incorporates the teachings of the invention into the sign 2, which contains text 5 and an image 7. For example, the “Place Speedpass HERE” and “Speedpass™” 5 with the associated illuminated tiger image 7 may be used at a gasoline station or in other applications where illumination is required behind an image 7 to provide instructions and/or other information, or to indicate, for example when a gas pump is operational. The sign 2 shown is only one example of any number of types of signs and images which may utilize the present invention.

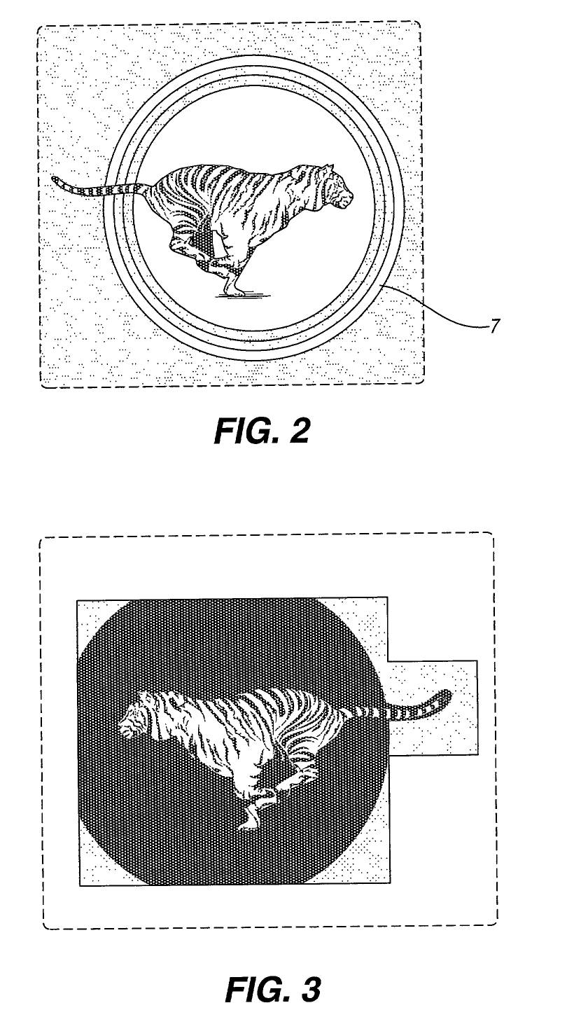

Referring now to FIGS. 2-5, an example of the image 7 portion of an entire sign 2 is shown herein. The image 7 is constructed such that a light source is obscured. Various layers are stacked in order to achieve this effect. As a result, the front and the rear of the image 7 will have different appearances as shown in FIG. 3, which depicts a real image of the sign shown in FIG. 2.

Referring now to FIG. 3, a front exploded view of the present invention is provided, and which depicts the various layers and substrates required to create a sign of the present invention. Initially, a substrate 8 is laid down which will provide a canvas for the sign's text 5 and images 7 and will also protect the image 7 when finished. In one embodiment, the substrate is made of pressure sensitive vinyl, liquid vinyl, self-cling vinyl, surface-treated polyester, polycarbonate, or a acrylic, or similar material, preferably Makrofol EPC 0.015 to 0.020 inches thick. A background color 9A is applied to the substrate. In one embodiment, the background color 9A is a dark blue high gloss, flexible ink sold by Coates™ as a color in the C99 series. The background color 9A is applied with a mesh of 255 openings/in² and a tension of 14-21 newtons, with regard to the screen used in the image manufacturing process. An additional ink series color combination 9B, such as the orange, may be utilized to create the image 7 and/or text. In one embodiment, the image 7 is created by a four-color process that includes the application of at least Coates™ C99/HG with a mesh of 255 openings/in² and a tension of 14-21 newtons, and Nazdar™ 9700 with a mesh of 355 openings/in² and a tension of 20-22 newtons. After the surface 9 is applied a visual inspection for anomalies and pinholes may be performed.

Numerous inks and the materials associated with the background 9A and the image 9B can be used. For example, END 7190, END 7248, END 7249, which are specific color indicators used in this example by Marconi Commerce Systems of Greensboro, N.C., and which identify specific tones and colors used to make various signs and graphic displays. As appreciated by one skilled in the art, the number of colors and inks utilized in any given backlit sign are essentially limitless and can be used in any combination as necessary to produce the desired backlit sign or display.

Next, another layer 11 of gloss vinyl ink is then provided on top of the previously painted surface 9, which includes in one embodiment a white ink such as Coates™ C99 11A. Preferably, this layer is applied with a mesh of 255 openings/in² and at a tension of 14-21 newtons. This layer 11 may also include additional inked portions 11B which match areas of the image 7 & 9B in order to add color or contrast to the final product. After the surface 11 is applied a visual inspection for anomalies and pinholes may be performed.

Subsequently, an additional layer 12 that acts to prevent unwanted light from emanating from the back is applied. In one embodiment, this opaquing layer 12 consist at least of a mixture of Coates™ Series C99 inks such as CRES-Lite #200, ET-10, and a viscosity reducer S103 (opaque white ink), applied with a mesh of 255 openings/in² and at a tension of 14-21 newtons. This layer 12 may also include and additional portions 12B which match areas of the image 7, 9B, & 11B in order to add color or contrast to the final product. Furthermore, an additional opaque layer of ink 13 which is merely the application of a second coat as identified herein, can be added to cover pinholes.

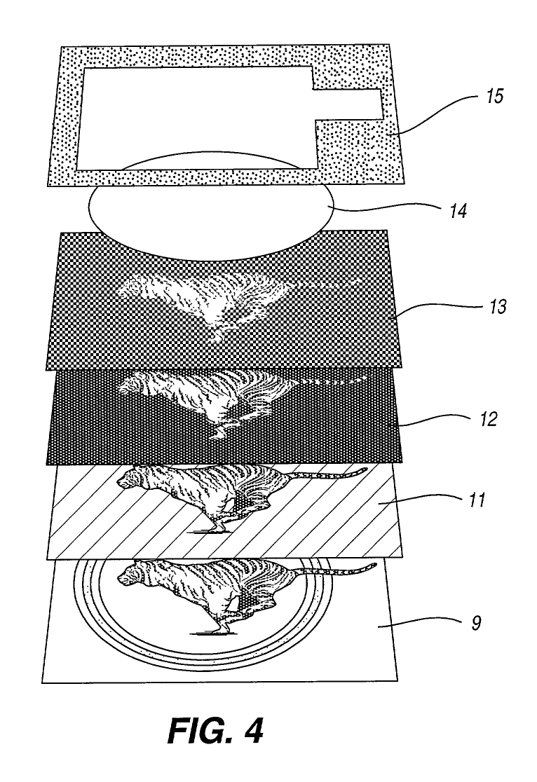

Referring again to FIG. 4, a diffuser layer 14, which disperses the light source in order to avoid “hot spots”, is now applied on top of the opaquing layer 12 or 13. In one embodiment, the diffusing layer 14 consists of a mixture of Coates™ Series C99, specifically S199 (a clear mixing agent), S103 (white opaque), and MAT-190 (matte additive), and is applied with a mesh of 255 holes/in² at a tension of 14-21 newtons. Alternatively, the matte additive can be omitted. After application, the diffusing layer may be inspected to ensure that the light sources are sufficiently dispersed. Preferably, no pinholes should be present and a photometer reading of 1050-1200 lumins should be read. It should be understood that the diffusing layer is applied between the image 7 and the light source 18, regardless of the intervening layers present. Alternatively, the diffusing layer 14 can be applied to another material, preferably silk screen, and then placed between the image 7 and the light source 18.

To create a sufficiently backlit sign which is capable of brightly illuminating an image 7 or sign 2, yet which diffuses the illuminating source to such a degree that the LED or other light source 18 is not visible from the viewing front, a specific and novel type of diffuser technique and method must be utilized. Thus, in one particular embodiment of the present invention Coates™ C99-S199, C99-S103, and Mat-190 inks are applied in the weight percentages as identified herein to formulate the composition of the diffuser 14. More specifically, the C99-S103 is a gloss vinyl ink which is an opaque white color while the C99-S199 is a gloss vinyl ink which has a clear color, while the Mat-190 is a matte additive used for mixing purposes. In one embodiment of the present invention, the C99-S199 is used in a percentage of between about 50% and 60%, and preferably 56%, the C99-S103 is used in a percentage of between about 20% and 30% and preferably 24%, while the matte additive Mat-190 is used in a range of between 10% and 25%, and preferably 20% for the application shown in the attached figures. Alternatively, it has been found that in one embodiment an adequate diffuser 14 can be formulated by entirely eliminating the Mat-190, and utilizing the S199 in a percentage of about 65%, and the S103 in a percentage of about 35%. Variations in the compositions of ink and weight percentages may be substituted as appreciated by one skilled in the art. The combination is preferably mixed inward for 15 minutes and then mixed outward for 15 minutes at a maximum blend speed of 10 using an M&R Turnabout D/C high speed mixer.

In order to further describe and enable one to construct this embodiment of the present invention the following table is provided.

| Index # | Ink/Formula | Mesh/Tension | Inspection |
|---|---|---|---|
| 8 | Makrofol EPC & similar | N/A | Visual for scratches on full |
| | .015 & .020 | | sheets before being cut to size. |
| | | | Cut sheets checked for scratches |
| | | | prior to printing. |
| 9A | Coates C99 | 255 openings/in² | Visual/Denso |
| | | 14-21 newtons | |
| 9B | Nazdar 9700 | 355 openings/in²/20-22 | Visual/Denso |
| | C99/HG | newtons | |
| | | 255 openings/in²/14-21 | |
| | | newtons | |
| 11 | Coates C99 | 255 openings/in² | Visual/Denso |
| | | 14-21 newtons | |
| 12 | Coates C99 | 255 openings/in² | Visual/Even coverage with no |
| | CRES-Lite #200 (75 g) | 14-21 newtons | pin holes. Also used behind |
| | ET-10 (50 g) (reducer) | | image area that is not backlit to |
| | S103 (385 g) (opaque white) | | show contrast. |
| 13 | Coates C99 | 255 openings/in² | Visual/Use only if necessary to |
| | CRES-Lite #200 (75 g) | 14-21 newtons | cover pin holes. |
| | ET-10 (50 g) (reducer) | | |
| | S103 (385 g) (opaque white) | | |
| 14 | Coates C99 | 255 openings/in² | Visual/18″ for 5 seconds, |
| | S199 (448 g) (mixing clear) | 14-21 newtons | perpendicular, eye level. No pin |
| | S103 (192 g) (opaque white) | | holes. Must not see diameter of, |
| | Mat-190 (160 g) (matte | | or count LEDs. Photometer |
| | additive) | | reading: 1050-1200 |
| 15 | 3M 468MP | N/A | Backlit area free of adhesive. |
| | Adhesive | | Selective cut not over image. |
| | | | Must pass adhesive pull test. |

To assist in the understanding of the present invention the following list of components and associated numbering found in the drawings is provided herein:

# Description

2 Sign

5 Text on a sign

7 Image on a sign

8 Substrate surface

9 Image coat(s)

9A Background color

9B Image color(s)

11 White flood layer

11A White flood ink

11B Image enhancing portion of white flood layer

12 Opaqueing layer

12A Opaqueing portion of the layer

12B Image enhancing portion of the opaqueing layer

13 Optional opaqueing layer

13A Opaqueing portion of the optional layer

13B Image enhancing portion of the optional opaqueing layer

14 Diffusing layer

15 Adhesive

16 Clear polycarbonate door

18 Light source(s)

As appreciated by one skilled in the art various percentages and combinations of the diffuser materials, and/or alternative materials and process steps may be utilized to obtain similar results as provided herein. Thus the present invention is not limited to the specific embodiment as set forth above and in the claims, but includes all equivalent compositions and process steps which capture the novelty of the present invention.

What is claimed is:

1. A backlit sign for providing an illuminated image, comprising:
a substrate layer having a front side and a backside;
an ink layer applied to said backside of said substrate having at least one distinct color;
a diffuser layer applied to said at least one distinct color and comprising:
a) an opaque white gloss vinyl ink;
b) a clear mixing gloss vinyl ink; and
a light source provided behind said diffuser layer, wherein an illuminated image may be displayed without substantially revealing said light source positioned behind said diffuser layer.

2. The backlit sign of claim 1, wherein said opaque white gloss vinyl ink has a percentage by weight of said diffuser layer of between 20%-40%, and said clear mixing gloss vinyl ink has a percentage by weight of said diffuser layer of between 50%-70%.

3. The backlit sign of claim 1, wherein said opaque white gloss vinyl is comprised of a Coates™ C99-S103 series of ink.

4. The backlit sign of claim 1, wherein said gloss vinyl ink is comprised of a Coates™ C99-S199 ink.

5. The backlit sign of claim 1, wherein said light source comprises at least one LED bulb.

6. The backlit sign of claim 1, further comprising an adhesive layer applied over said ink layer, omitting portions where said light source will shine through, and wherein said backlit sign may be adapted to be selectively secured to a surface.

7. The backlit sign of claim 1, further comprising a transparent adhesive layer applied over said ink layer, wherein said backlit sign may be adapted to be secured to a surface.

8. The backlit sign of claim 1, wherein said diffuser layer is applied to a silk screen having at least about 200 openings/in², wherein said diffusing layer is applied to said silk screen at a tension of 14-21 newtons, and said silk screen is overlaid adjacent to said ink layer.

9. The backlit sign of claim 1, further comprising at least one additional ink layer applied to said ink layer in order to form a multicolored object.

10. The backlit sign of claim 1, further comprising a matte additive ink added to said opaque while gloss vinyl ink and said clear mixing gloss vinyl ink in a weight percentage by weight of said diffuser layer of between about 10-25%.

11. The backlit sign as in claim 10, further comprising:
a high gloss flexible ink layer applied between said background layer and said image layer and said diffusing layer;
at least one opaqueing silver ink layer applied between said high gloss flexible ink layer and said diffusing layer.

12. A method of constructing a portion of a backlit sign comprising the steps of:
applying a background ink layer of at least one color to a substantially transparent surface capable of transmitting light; applying an image ink layer of at least one color to said surface;
applying a high gloss, flexible ink layer onto said background ink layer and onto portions of said image ink layer;
applying at least one opaqueing layer which includes a gloss vinyl ink;
creating mixture of at least an opaque white gloss vinyl ink that has a percentage by weight of said mixture of 20%-40% and a gloss vinyl ink that has a percentage by weight of said mixture of 50%-70%, wherein said mixture is capable of diffusing light;
applying said mixture onto at least one portion of said image ink layer; and placing a light source adjacent to said mixture wherein the light that emanates from said light source is sufficiently diffused when viewed from the opposite side of said sign.

13. The method of claim 12 further comprising the step of:
applying a layer of adhesive over said ink layer, wherein said portion of a backlit sign may be adapted to be secured to a surface.

14. A method of constructing a backlit sign comprising the steps of:
applying a background ink layer of at least one color to a substantially transparent surface capable of transmitting light;
applying an image ink layer of at least one color to said surface;
applying a high gloss, flexible ink layer onto said background ink layer and onto portions of said image ink layer;
applying at least one opaque layer onto said high gloss, flexible layer;
applying a diffusing layer onto said opaque layer;

15. The method of claim 14 further comprising the step of: applying a layer of adhesive onto portions of said opaqueing layer, wherein said backlit sign may be secured to a surface.

16. The method of claim 14 wherein said substantially transparent surface is made primarily of Makrofol EPC, said high gloss layer is made of Coates™ C99, said opaque layer is made primarily of Coates™ C99-S103, and said diffusing layer contains at least Coates™ C99-S199 and C99-S103.
